(19) United States
(12) Patent Application Publication
(10) Pub. No.: US 2022/0035272 A1
(43) Pub. Date: Feb. 3, 2022

(54) CONTROLLING SUPPLY OF MAGNETIC MATERIAL

(71) Applicant: HEWLETT-PACKARD DEVELOPMENT COMPANY, L.P., Spring, TX (US)

(72) Inventors: Gabriel S. McDaniel, Boise, ID (US); Sean Daniel FitzGerald, Boise, ID (US)

(21) Appl. No.: 17/309,389

(22) PCT Filed: Jul. 15, 2019
(86) PCT No.: PCT/US2019/041806

§ 371 Date: May 24, 2021

(51) Int. Cl. G03G 15/09; B41J 2/43; G03G 13/09

(52) U.S. Cl. CPC G03G 15/09; B33Y 40/00; G03G 13/09; B41J 2/43

(57) ABSTRACT

An example magnetic material supply apparatus includes a reservoir to contain a magnetic material, a connecting member having a first end coupled to the reservoir to receive the magnetic material, and a magnet. A magnetic field produced by the magnet controls supply of the magnetic material through the connecting member.

### BACKGROUND

A printing process may use a magnetic material. As an example, a developer used in an electrophotographic printing process may include a magnetic toner or a magnetic carrier that is attracted to a magnetic developing roller. As another example, a three-dimensional (3-D) printing process may use a magnetic material as a source for additive manufacturing. In these or similar printing processes, controlling a supply of the magnetic material is an important consideration.

### BRIEF DESCRIPTION OF DRAWINGS

Certain examples of the present disclosure will be more apparent from the following description taken in conjunction with the accompanying drawings, in which:

FIGS. 1A-1D illustrate a magnetic material supply apparatus according to an example;

FIG. 2 illustrates a printing engine including a magnetic material supply apparatus according to an example; and

FIG. 3 is a block diagram of an image forming apparatus including a magnetic material supply apparatus according to an example.

Throughout the drawings, it should be noted that like reference numbers are used to depict the same or similar elements, features, parts, components, and structures.

### DESCRIPTION OF EXAMPLES

Various examples will be described more fully hereinafter with reference to the accompanying drawings. The examples described hereinafter may be modified in many different forms.

Throughout the description, when an element is referred to as being “connected” or “coupled” to another element, it can be directly connected or coupled to the other element or it can be connected or coupled to the other element with intervening elements interposed therebetween.

In the following description, a singular expression includes a plural expression, unless otherwise specified. It is also to be understood that terms such as “comprises” or “includes” are used herein to designate the presence of a characteristic, a number, a step, an operation, an element, a component, or a combination thereof, and not to preclude the presence or the possibility of adding one or more of other characteristics, numbers, steps, operations, elements, components, or a combination thereof. It is also to be understood that terms such as “first,” “second,” or the like are used to differentiate between objects having the same or similar terminology and are in no way intended to represent an order, unless where explicitly stated otherwise.

In the following description, when a material is referred to as “magnetic,” the material may be a ferromagnetic material, a ferrimagnetic material, or other type of material that exhibits a response to a magnetic field. In the following description, an “image forming apparatus” may refer to an apparatus that prints print data generated in a terminal apparatus, such as a computer, on a recording medium, such as paper. Examples of an image forming apparatus may include a copier, a printer, a scanner, a fax machine, a multi-function printer (MFP) that complexly realizes various functions through one apparatus, and the like. Furthermore, an image forming apparatus may refer to a three-dimensional (3D) printer that prints or creates a 3D object using an additive manufacturing process. In the following description, an “image forming job” may denote any one of various jobs (for example, printing, copying, scanning, and faxing) related to an image, such as forming of an image or generating/storing/transmitting of an image file, and a “job” may denote not only an image forming job, but may also denote a series of processes required to perform the image forming job.

Various types of image forming apparatuses may employ a magnetic material that is used as part an image rendering process. For example, a toner used in a one-component electrophotographic (EP) printing process may be magnetic. In a two-component EP printing process, both the toner and a carrier may be magnetic. Further, in a color printing process, a colorant particulate may be magnetic. In a 3D printing process, a powder, a particle, or other material used for additive manufacturing may have magnetic properties. During use of any of these or similar image forming apparatuses, it is often necessary to control the supply of these or other magnetic materials.

As an example, a developer used in a two-component EP printing process may include a toner and a carrier. For purposes of this example, it is assumed that the carrier is a magnetic material while the toner may or may not be a magnetic material. In such a developer, the toner may have a longer life span as compared to the carrier, such that the life span of the developer is limited by the life span of the carrier. In the case of an image forming apparatus using such a developer, it may be necessary to cease operation of the image forming apparatus in order to replenish and/or replace the carrier. However, ceasing operation of the image forming apparatus to replenish and/or replace the carrier may cause an inconvenience for a user. In such an image forming apparatus, it would increase convenience of the user if new carrier could be added to the developer without the need to cease the operation of the image forming apparatus.

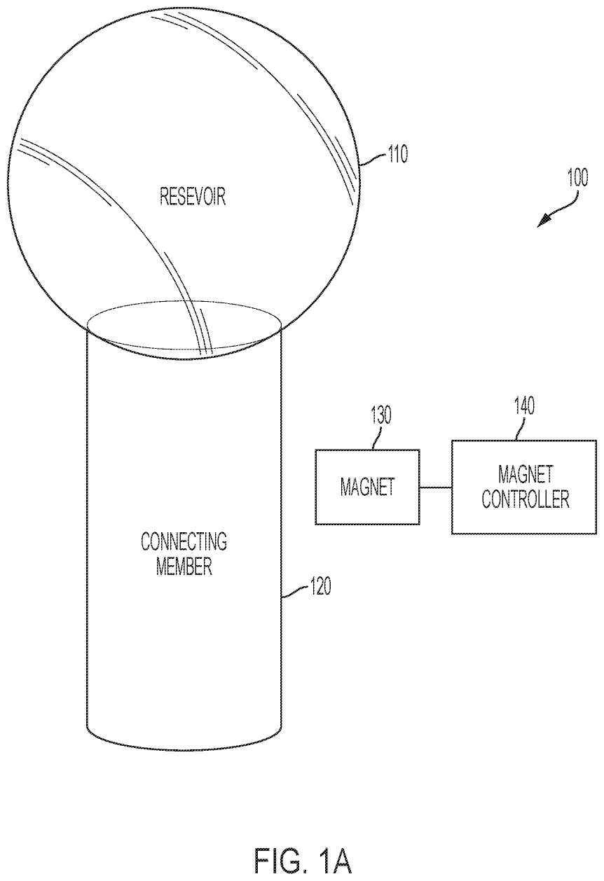

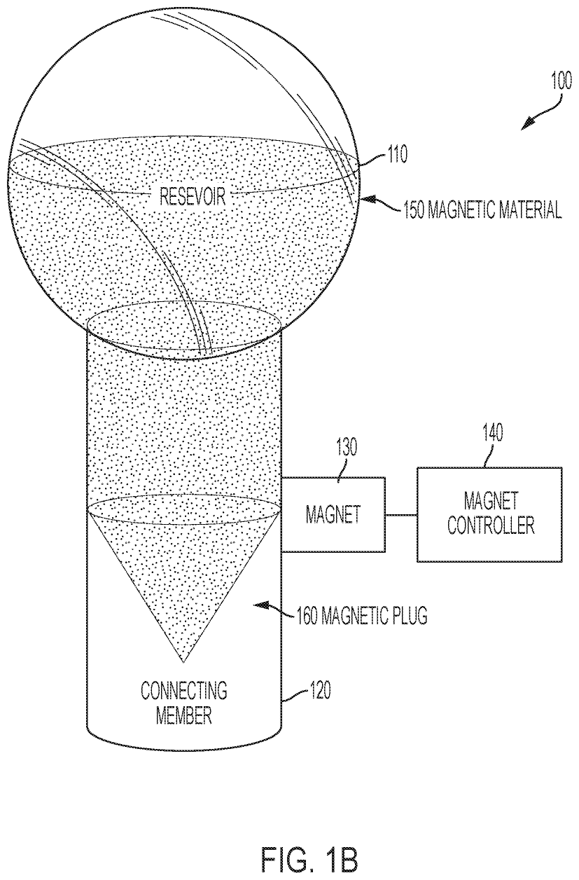

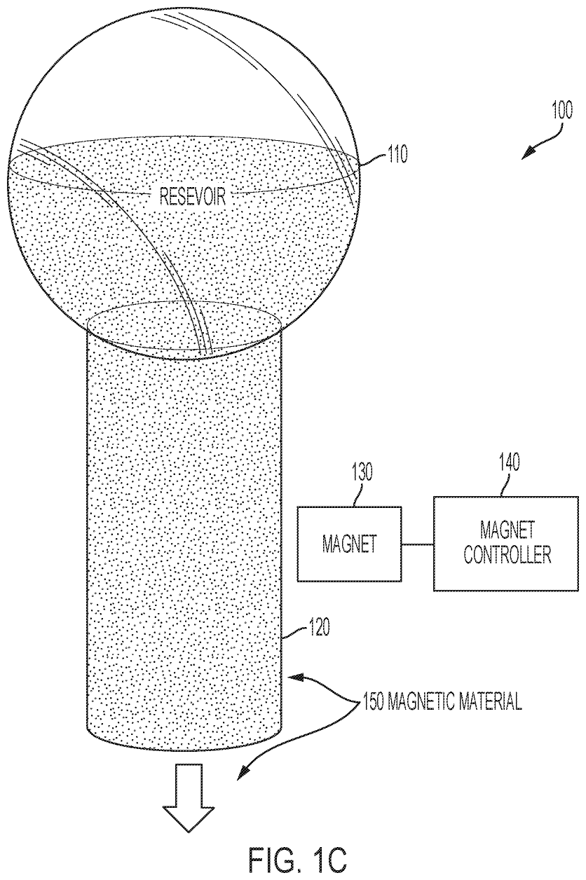

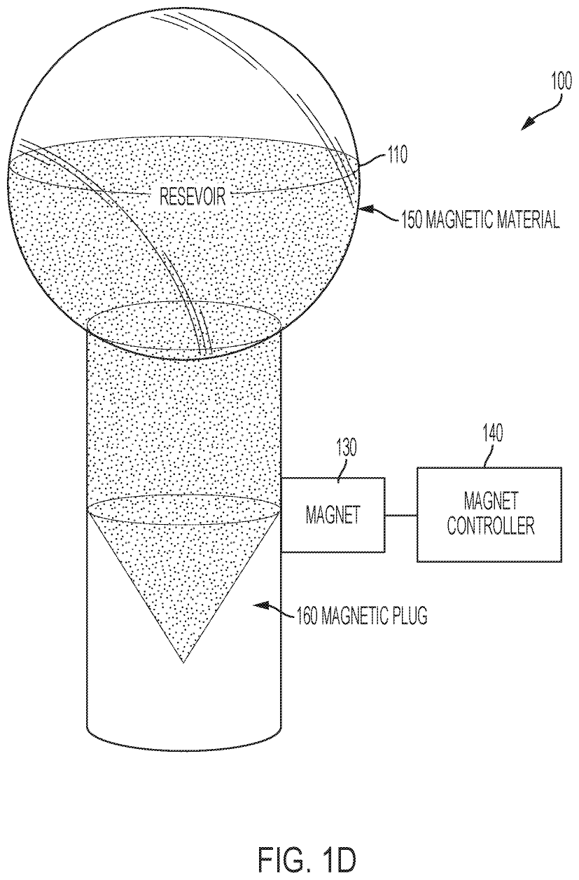

FIGS. 1A-1D illustrate a magnetic material supply apparatus according to an example.

Referring to FIG. 1A, a magnetic material supply apparatus 100 may include a reservoir 110, a connecting member 120, a magnet 130, and a magnet controller 140.

The reservoir 110 may include a first container or a volume to receive a magnetic material. As an example, in a system using a two-component EP printing process, the reservoir 110 may receive a magnetic carrier therein. In other examples, the reservoir 110 may receive a magnetic toner, a magnetic material for additive manufacturing, a magnetic colorant, or the like. Although the reservoir 110 is illustrated in FIG. 1A as having an oval shape, the shape of the reservoir 110 is not limited thereto. For example, the reservoir 110 may have any of or a combination of a circular shape, a rectangular shape, a triangular shape, a hem i-spherical shape, or the like.

In various examples, a size or a volume of the reservoir 110 may be determined based on various aspects of the system in which the magnetic material supply apparatus 100 may be used, a purpose of the magnetic material received therein, etc. As an example, if the magnetic material supply apparatus 100 is to receive a magnetic carrier for use in a developer of a two-component EP process (i.e., a developer that includes toner and magnetic carrier), the size or the volume of the reservoir 110 may correspond to a volume of toner, an expected life of the toner, a volume of a developing cartridge, etc.

A bottom surface of the reservoir 110 may connect or couple to the connecting member 120 and include an opening to allow the magnetic material to pass from the reservoir 110 to the connecting member 120. In an example, the shape or topography of the bottom surface of the reservoir 110 may be inclined relative to the connecting member 120 to assist in a gravity feed of the magnetic material received in the reservoir 110 towards the connecting member 120.

The connecting member 120 may connect or couple to the reservoir 110 to receive the magnetic material contained in the reservoir 110. In the illustrated example, the connecting member 120 is provided as an open cylinder or tube having an opening located at a first end. The opening located at the first end of the connecting member 120 may correspond to the opening in the bottom surface of the reservoir 110 to receive the magnetic material contained in the reservoir 110. The connecting member 120 may also have an opening at a second end, the second end located opposite to the first end.

Although the connecting member 120 is illustrated as having an open cylinder or tube shape, a shape of the connecting member 120 is not limited thereto. For example, the connecting member 120 may have any of various shapes that provide for supplying or transferring the magnetic material from the first end of the connecting member 120 to the second end of the connecting member 120. As an example, the connecting member 120 may have a continuous cross-section in the shape of an oval, a square, a triangle, or the like. As another example, the connecting member 120 may have more than one cross-sectional shape depending on its implementation. As another example, a cross section of the connecting member 120 may increase as it approaches either or both of the first end coupled to the reservoir 110 and the second end that is opposite to the first end. In various examples, the reservoir 110 and the connecting member 120 may be integrally formed or may be separately formed and connected or coupled to each other.

The magnet 130 may provide a magnetic field to control supply of the magnetic material contained in the reservoir 110. In various examples, the magnet 130 may be a permanent magnet or an electromagnet. A field strength of the magnet 130 to be used in the magnetic material supply apparatus 100 may be determined based on various aspects of the system in which the magnetic material supply apparatus 100 may be used. For example, the magnetic field strength of the magnet 130 may depend on material properties of the magnetic material to be received in the reservoir 110 (e.g., a material type, a material size, a material weight, a magnetic permeability, etc.), an amount of control needed to supply the magnetic material, properties of the connecting member 120 (e.g., a sidewall thickness, a diameter, a material type, magnetic permeability, etc.), or the like.

In FIGS. 1A-1D, a single magnet 130 is illustrated. However, this is merely an example and it is understood that a plurality of magnets 130 may be provided. For example, if the magnet 130 is implemented as a permanent magnet, two or more magnets 130 may be provided at various locations around the connecting member 120. In that example, the plurality of magnets 130 may be respectively controlled by a plurality of magnet controllers 140 or may be controlled by a single magnet controller 140. Furthermore, the plurality of magnets 130 may have the same or different polarities of magnetic fields with respect to the connecting member 120 to control movement of the magnetic material through the connecting member 120. A location of each of the plurality of magnets 130 may be individually controlled to realize a desired magnetic field applied at the connecting member 120 to control movement of the magnetic material. In another example, if the magnet 130 is implemented as an electromagnet, the magnet 130 may be implemented as a plurality of magnets 130 provided at various locations around the connecting member 120 or as a continuous magnet surrounding the connecting member 120. In an example, a magnetic field of each of the plurality of magnets 130 implemented as electromagnets may be individually controlled to realize a desired magnetic field applied at the connecting member 120 to control movement of the magnetic material.

The magnet controller 140 may be provided in various forms corresponding to whether the magnet 130 is implemented as a permanent magnet or an electromagnet. In an example in which the magnet 130 is provided as a permanent magnet, the magnet controller 140 may provide an electro-mechanical control of the location of the magnet 130. As an example, the magnet controller 140 may control to move the magnet 130 between a first position and a second position. In implementation, the magnet controller 140 may be implemented as a solenoid, an actuator, an articulating arm, a worm gear, or the like.

In an example in which the magnet 130 is provided as an electromagnet, the magnet controller 140 may provide an electrical control of the magnetic field of the magnet 130. For example, the magnet controller 140 may increase or decrease a supply of voltage or current to the magnet 130 to increase or decrease the magnetic field exerted by the magnet 130.

Examples of using the magnet 130 to control supply of a magnetic material will be provided below with reference to FIGS. 1B-1D.

Referring to FIG. 1B, an example is provided in which the magnet 130 is to prevent a magnetic material 150 received in the reservoir 110 and the first end of the connecting member 120 from being supplied through the connecting member 120 to the second end of the connecting member 120.

In an example in which the magnet 130 is provided as a permanent magnet, the magnet controller 140 may control to locate to the magnet 130 in a first position relative to the connecting member 120. In an example, the first position is proximate to or abutting the connecting member 120. In the first position, the magnetic field produced by the magnet 130 may penetrate the connecting member 120 to prevent the magnetic material received in the reservoir 110 and at the first end of the connecting member 120 from passing through the connecting member 120 to the second end of the connecting member 120. In this case, the magnetic field produced by the magnet 130 may create a magnetic plug 160 within the connecting member 120.

In an example in which the magnet 130 is provided as an electromagnet, the magnet controller 140 may control a voltage or current provided to the magnet 130 so that the magnetic field produced by the magnet 130 prevents the magnetic material received in the reservoir 110 and at the first end of the connecting member 120 from passing through the connecting member 120 to the second end of the connecting member 120 and causes the magnetic plug 160 to form. In the example of FIG. 1B, the magnet 130 may be positioned or controlled so that the magnetic field produced by the magnet 130 may prevent the magnetic material 150 received in the reservoir 110 and the first end of the connecting member 120 from reaching the second end of the connecting member 120.

Referring to FIG. 1C, an example is provided in which the magnet 130 allows the magnetic material 150 received in the reservoir 110 and the first end of the connecting member 120 to be supplied through the connecting member 120 to the second end of the connecting member 120.

In an example in which the magnet 130 is provided as a permanent magnet, the magnet controller 140 may control to locate to the magnet 130 in a second position relative to the connecting member 120. In an example, the second position is away from the connecting member 120 by a distance that reduces or eliminates an effect of the magnetic field produced by the magnet 130 on the magnetic material 150 received in the connecting member 120. In that regard, the location of the second position may depend on various parameters of the connecting member 120 and the magnetic material 150 (e.g., a material type, a material size, a material weight, a magnetic permeability, etc.).

In an example in which the magnet 130 is provided as a permanent magnet, the magnetic field produced by the magnet 130 and applied at the connecting member 120 may be reduced or eliminated by use of a second permanent magnet (not shown) having a magnetic field opposite to that of the permanent magnet 130. In an example, the second permanent magnet may be positioned or re-positioned such that its magnetic field reduces or otherwise compromises the magnetic field applied by the magnet 130 to allow the magnetic material 150 received in the reservoir 110 and the first end of the connecting member 120 to be supplied through the connecting member 120 to the second end of the connecting member 120. The second permanent magnet may be controlled by the magnet controller 140 or controlled by a separate controller similar to the magnet controller 140.

In an example in which the magnet 130 is provided as a permanent magnet, the magnetic field produced by the magnet 130 may be reduced or eliminated by use of a material (not shown) having a high magnetic permeability. In that case, the high magnetic permeability material may be placed intermediary to the magnet 130 and the connecting member 120 to reduce or eliminate an effect of the magnetic field produced by the magnet 130 on the magnetic material 150 received in the connecting member 120. The positioning of the high magnetic permeability material may be controlled by the magnet controller 140 or controlled by a separate controller similar to the magnet controller 140.

In an example in which the magnet 130 is provided as an electromagnet, the magnet controller 140 may control a voltage or current provided to the magnet 130 so that the magnetic field of the magnet is eliminated or reduced to a value that allows supply of the magnetic material 150 through the second end of the connecting member 120.

In an example, in which the magnet 130 is provided as an electromagnet, the magnetic field produced by the magnet 130 and applied at the connecting member 120 may be reduced or eliminated by use of a second electromagnet (not shown) having a magnetic field opposite or otherwise magnetically contrary to that of the electromagnet magnet 130. In an example, the second electromagnet may be controlled such that its magnetic field reduces or otherwise compromises the magnetic field of the magnet 130 to allow the magnetic material 150 received in the reservoir 110 and the first end of the connecting member 120 to be supplied through the connecting member 120 to the second end of the connecting member 120. The second electromagnet may be controlled by the magnet controller 140 or controlled by a separate controller similar to the magnet controller 140.

Referring to FIG. 1D, an example is provided in which the magnet 130 is to stop or prevent the magnetic material 150 from being supplied through the connecting member 120 to the second end of the connecting member 120. In the example of FIG. 1D, the magnetic material 150 is initially being supplied through the connecting member 120 to the second end of the connecting member 120, as illustrated in the example of FIG. 1C. In that case, it may be desired to prevent further supply of the magnetic material 150.

In an example in which the magnet 130 is provided as a permanent magnet, the magnet controller 140 may control to re-locate the magnet 130 to the first position relative to the connecting member 120. In the first position, the magnetic field produced by the magnet 130 may penetrate the connecting member 120 to re-create the magnetic plug 160 and prevent the magnetic material 150 received in the reservoir 110 and at the first end of the connecting member 120 from passing through the connecting member 120 to the second end of the connecting member 120. In an example in which the magnet 130 is provided as an electromagnet, the magnet controller 140 may control a voltage or current provided to the magnet 130 so that the magnetic field produced by the magnet 130 re-creates the magnetic plug 160. In that case, the magnetic field produced by the magnet 130 is to prevent the magnetic material 150 received in the reservoir 110 and at the first end of the connecting member 120 from passing through the connecting member 120 to the second end of the connecting member 120. Upon formation of the magnetic plug 160, magnetic material 150 located between the magnetic plug 160 and the second end of the connecting member 120 will continue to the second end of the connecting member 120 and exit therefrom.

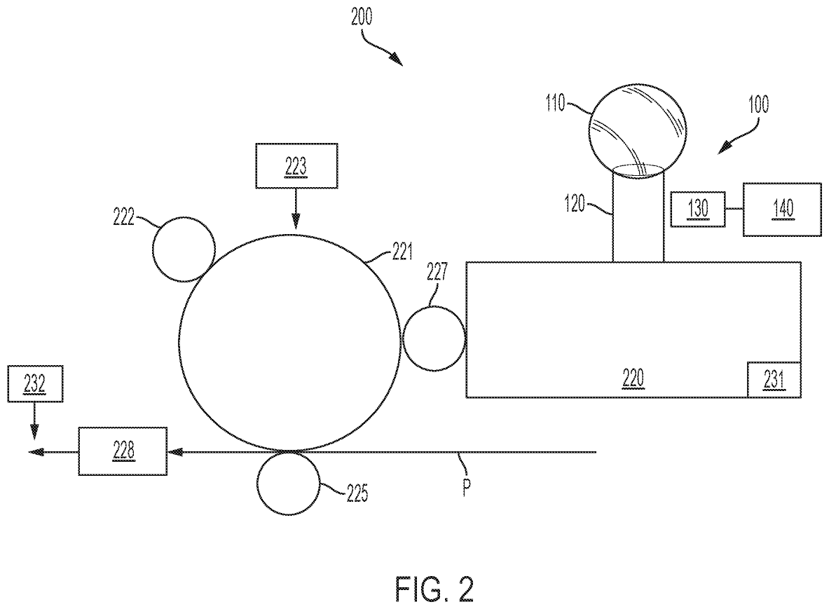

In various examples, the magnetic material supply apparatus 100 may be installed or otherwise included in an image forming apparatus to control supply of a magnetic material used in an image forming job. For example, the magnetic material supply apparatus 100 may be installed or otherwise included in an image forming apparatus used in an EP printing process, an image forming apparatus used in a color printing process, an image forming apparatus used in a liquid printing process, an image forming apparatus used in a 3D printing process, or the like. An example in which the magnetic material supply apparatus 100 is included in an EP printing process is described with reference to FIG. 2.

FIG. 2 illustrates a printing engine including a magnetic material supply apparatus according to an example.

Referring to FIG. 2, a printing engine 200 may be provided as part of an image forming apparatus that forms an image using an EP printing process. The printing engine 200 may include a developer cartridge 220, a photosensitive drum 221, a charging device 222, an exposure device 223, a transcription device 225, a fusing device 228, a magnetic carrier sensor 231, and a print sensor 232.

On the photosensitive drum 221, an electrostatic latent image is formed. The photosensitive drum 221 may be referred to as a photosensitive drum, a photosensitive belt, etc., according to its shape. The charging device 222 charges the surface of the photosensitive drum 221 with a homogenous potential. The charging device 222 may be implemented as a corona charging device, a charging roller, a charging brush, etc. The exposure device 223 changes the surface potential of the photosensitive drum 221 according to information on the image to be printed, and thereby forms an electrostatic latent image on the surface of the photosensitive drum 221.

The developer cartridge 220 accommodates developer and develops an electrostatic latent image into a visible image by providing the developer to the electrostatic latent image formed on the photosensitive drum 221. The developer cartridge 220 may include a developing roller 227 that provides toner to the electrostatic latent image.

In an example of a two-component EP printing process, the developer cartridge 220 may accommodate a magnetic carrier and a toner. In this case, the developing roller 227 may include a rotatable sleeve and a magnet provided inside the sleeve. The magnetic carrier is attached to an outer periphery of the developing roller 227 by a magnetic force of the developing roller 227 and the toner is adhered to the magnetic carrier by electrostatic force so that a magnetic brush formed of the magnetic carrier and toner is formed on the outer periphery of the developing roller 227. The toner is moved to the electrostatic latent image formed on the photosensitive drum 221 by a developing bias voltage applied to the developing roller 227.

A visual image formed on the photosensitive drum 221 is transcribed to a recording medium P by the transcription device 225 or an intermediate transcription belt (not shown). The fusing device 228 fuses the visible image on the recording medium P by applying heat or pressure to the visual image on the recording medium P. By a series of processes as described above, a printing job is completed.

In the example of FIG. 2, the toner contained in the developer cartridge 220 may be able to produce acceptable print performance for a longer duration than the magnetic carrier. That is, the toner contained in the developer cartridge 220 may have a longer life span than the magnetic carrier contained in the developer cartridge 220. In that case, it is necessary to replace or replenish the magnetic carrier contained in the developer cartridge 220. One process of replacing or replenishing the magnetic carrier includes ceasing operation of the printing engine 200, removing the developer cartridge 220, removing the existing magnetic carrier from within the developer cartridge 220, inserting new magnetic carrier into the developer cartridge 220, replacing the developer cartridge 220, and resuming operation of the printing engine 200. This process may require an extended outage of the printing engine 200 or the need for a trained service technician, either of which causes an inconvenience and increased costs for a user. To address these inconveniences and costs, the example of FIG. 2 provides the printing engine 200 with a magnetic material supply apparatus 100 to allow for selective provision of magnetic carrier.

In the example of FIG. 2, the second end of the connecting member 120 may connect or couple to a surface of the developer cartridge 220. In an example, the developer cartridge 220 may include an opening corresponding to the second end of the connecting member 120 to receive magnetic material from the connecting member 120. In another example, the magnetic material supply apparatus 100 may be provided internally to the developer cartridge 220 such that the second end of the connecting member 120 is open to an internal volume of the developer cartridge 220, that may be considered a second container. In the example of FIG. 2, the reservoir 110 of the magnetic material supply apparatus 100 may receive a volume of magnetic carrier, the supply of which is controlled by the magnet 130 and the magnet controller 140.

In an example, the printing engine 200 may further include the magnetic carrier sensor 231 and the print sensor 232. The magnetic carrier sensor 231 may determine a quality of the magnetic carrier that is included in the developer cartridge 220. As an example, the magnetic carrier sensor 231 may determine a ratio of toner to magnetic carrier, may determine a magnetic characteristic of the magnetic carrier, etc. In an example, the magnetic carrier sensor 231 may determine that a quantity or a quality of the magnetic carrier is below a corresponding threshold. In that case, the magnetic carrier sensor 231 may output a signal indicating the determined status. In an example, the magnetic carrier sensor 231 may output a signal corresponding to a measured value of quantity or quality of the magnetic carrier to a processor (not shown) so that the processor may determine a status of the magnetic carrier.

In an example, because the quality or quantity of the magnetic carrier in the developing cartridge 220 may impact the quality of a print job, the print sensor 232 is provided to determine the quality of the print job. In an example, the printing engine 200 may be controlled to print a test pattern and the print sensor 232 may determine a print quality based on an analysis of the test pattern. In a case in which the print sensor 232 determines that the print quality is below a threshold, the print sensor 232 may output a signal indicating the determined status. In an example, the print sensor 232 may output a signal corresponding to determined print quality to a processor (not shown) so that the processor may determine a status of the print quality.

In an example, based on a signal output from the magnetic carrier sensor 231 or a signal output from the print sensor 232 indicating that a quantity or quality of the magnetic carrier is below a threshold, the magnetic material supply apparatus 100 may control to provide magnetic carrier to the developer cartridge 220. In more detail, the magnet controller 140 may control the magnet 130 to allow magnetic carrier received in the reservoir 110 and at the first end of the connecting member 120 to be supplied through the connecting member 120 to the second end of the connecting member 120.

In an example, a quantity of magnetic carrier supplied from the reservoir 110 may depend on various considerations. For example, an amount of supplied magnetic carrier may depend on a remaining expected life span of a toner contained in the developing cartridge, an amount of toner contained in the developer cartridge 220, or the like. In an example, the magnetic material supply apparatus 100 may be controlled to supply an entire volume of magnetic carrier contained in the reservoir 110 to the developer cartridge 220. In that case, if the magnet 130 is implemented as a permanent magnet, the magnet controller 140 may control to move the magnet 130 from the first position to the second position for a determined amount of time and move from the second position to the first position after expiration of the determined amount of time. Here, the determined amount of time may correspond to the remaining volume of magnetic carrier to be provided to the developer cartridge 220. Similarly, if the magnet is provided as an electromagnet, the magnet controller 140 may control to reduce or eliminate the voltage or current supplied to the magnet 130 for an amount of time corresponding to the remaining volume of magnetic carrier to be provided to the developer cartridge 220.

In another example, the magnetic material supply apparatus 100 may be controlled to supply a percent of a remaining volume of magnetic carrier or a specific amount of magnetic carrier contained in the reservoir 110 to the developer cartridge 220. In that case, if the magnet 130 is implemented as a permanent magnet, the magnet controller 140 may control to move the magnet 130 from the first position to a third position, the third position intermediate the first position and the second position. In the third position, the magnetic field of the magnet 130 may be used to selectively control the transfer of magnetic carrier to the developer cartridge 220 at a desired rate. In the third position, the magnetic field of the magnet 130 is stronger at the connecting member 120 so that the flow of magnetic carrier is reduced as compared to the second position but reduced at the connecting member 120 so that the flow of magnetic carrier is not prevented as compared to the first position. Similarly, if the magnet 130 is implemented as an electromagnet, the magnet controller 140 may control a voltage or current supplied to the magnet 130 to produce a magnetic field to selectively control the transfer of the magnetic carrier.

In the example of FIG. 2, a single printing engine 200 is illustrated. However, in various examples, an image forming apparatus may include a plurality of printing engines 200. For example, in an image forming apparatus using cyan, magenta, yellow, and black printing colors, a printing engine 200 may be provided for each of the four colors. In that case, each printing engine 200 including a magnetic material supply apparatus 100 may be implemented in a manner similar to that illustrated in FIG. 2 and may selectively provide magnetic material from a reservoir 110 for each color.

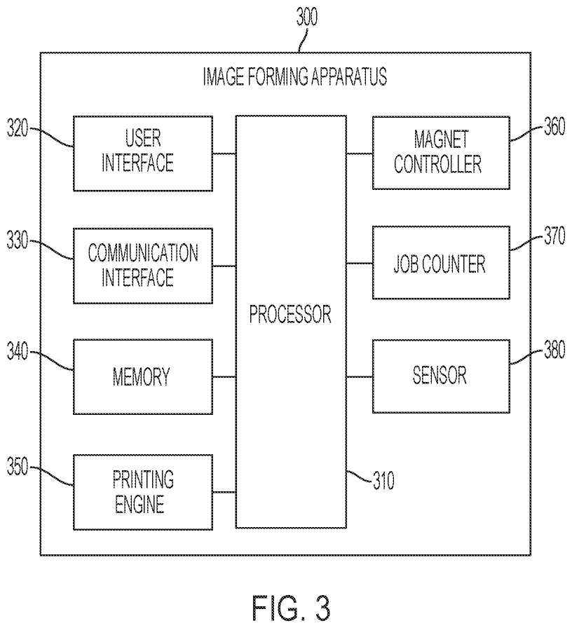

FIG. 3 is a block diagram of an image forming apparatus including a magnetic material supply apparatus according to an example.

Referring to FIG. 3, an image forming apparatus 300 may perform an image forming job such as copying, printing, scanning, or faxing. The image forming apparatus 300 may form an image on a recording medium such as printing paper in various manners such as an electrophotographic method, an inkjet method, a heat transfer method, a thermosensitive method, and the like. In an example, the image forming apparatus 300 may be a 3D printer to perform an additive manufacturing process.

The image forming apparatus 300 may include a processor 310, a user interface 320, a communication interface 330, a memory 340, a printing engine 350, a magnet controller 360, a job counter 370, and a sensor 380.

The processor 310 may control operations of the image forming apparatus 300 and may include at least one processor such as a central processing unit (CPU). The processor 310 may control other components included in the image forming apparatus 300 to perform an operation corresponding to a request received through the user interface device 320 or the communication interface 330. The processor 310 may include at least one specialized processor corresponding to each of various functions or may be a processor of an integrated type. The processor 310 may execute programs stored in the memory 340, may read data or files stored in the memory 340, or may store new files in the memory 340.

The user interface device 320 may include an input unit, which receives an input for performing an image forming job, etc. and an output unit which displays information such as a status of a magnetic material used for an image forming job, a result of performing an image forming job, a result of determining a print quality of the image forming apparatus 300, a correction result, etc.

The communication interface 330 may perform wired/wireless communication with other devices or a network. To this end, the communication interface 330 may include a communication module (e.g., transceiver) for supporting at least one of various wired/wireless communication methods. The wireless communication may be, for example, Wi-Fi, Wi-Fi Direct, Bluetooth, Bluetooth Low Energy (BLE), Ultra-Wide Band (UWB), Near Field Communication (NFC), or the like. The wired communication may be, for example, Ethernet, a universal serial bus (USB), a High Definition Multimedia Interface (HDMI), and the like.

The communication interface 330 may be connected to an external device outside the image forming apparatus 300 and may receive/transmit signals or data. In an example, the communication interface 330 may transmit a result or data obtained by the sensor 380 to the external device and receive an instruction based on the result or data from the external device. In an example, the external device may correspond to a service technician, a manager, or other entity that may control the image forming apparatus 300.

In the memory 340, various types of data, for example, files and programs such as applications, may be stored. The processor 310 may access and use the data stored in the memory 340, may store new data in the memory 340 or may execute the programs installed in the memory 340. Also, the processor 310 may install, in the memory 340, applications received from the outside through the communication interface 330. In an example, the memory 340 may store threshold values or other data to be used to determine whether to supply a magnetic material to the printing engine 350 using the magnet controller 360. As an example, the memory may store an expected life span of a toner, a volume of a developer, a threshold value of a print quality, a threshold value of a magnetic carrier quality, a threshold ratio of toner to magnetic carrier, a threshold number of image forming jobs, etc.

The printing engine 350 may perform an image forming job such as copying, printing, scanning, faxing, 3D additive manufacturing, etc. Also, the printing engine 350 may perform a mono-color printing, a color-printing, or the like. In any of the image forming jobs, the printing engine 350 may use a magnetic material. For example, the printing engine 350 may use a magnetic carrier in a two-component EP printing process, a magnetic toner in a one-component EP printing process, a magnetic colorant in a color printing process, a magnetic powder or particle in a 3D printing process, or the like.

The magnet controller 360 may control a location of a permanent magnet or control a voltage or current supplied to an electromagnet. In an example, the magnet controller 360 may receive an input from the processor 310 according to an instruction received through the user interface 320, an instruction received through the communication interface 330, an input received from the job counter 370, a signal received from the sensor 380, etc. In an example, the magnet controller 360 may control to move a location of a permanent magnet between a first position and a second position to control the supply of a magnetic material. In an example, the magnet controller 360 may control the permanent magnet to be located at a third position, intermediate the first position and the second position, to selectively supply a magnetic material at a desired rate or amount.

The job counter 370 may determine a number of image forming jobs performed by the printing engine 350. The job counter 370 may store the determined number of image forming jobs in the memory 340 or provide the determined number of image forming jobs to the processor 310. Based on the determined number of image forming jobs, the processor 310 may control the magnet controller 360 to supply a magnetic material to the printing engine 350. For example, a threshold number of image forming jobs may be determined at which the print quality of the printing engine 350 is expected to degrade. In that case, if the determined number of image forming jobs exceeds the threshold, the processor 310 may control the magnet controller 360 to supply a magnetic material. In another example, upon receiving the indication from the job counter 370 that the number of image forming jobs exceeds the threshold, the processor 310 may request input from the sensor 380 to determine other parameters of the image forming apparatus 300.

The sensor 380 may sense a parameter of the image forming apparatus 300. In an example, the sensor may include one or more sensors such as a magnetic material sensor, a print quality sensor, etc. The sensor 380 may store a value corresponding to a sensed parameter of the image forming apparatus 300 in the memory 340 or provide the value corresponding to the sensed parameter to the processor 310. In an example, if a value corresponding to a sensed parameter exceeds a threshold value, the processor 310 may control the magnet controller 360 to supply a magnetic material.

The processor 310 may execute instructions stored in the memory 340 and may control the magnet controller 360 to supply a magnetic material used by the image forming apparatus 300 in an image forming job. The processor 310 may obtain information of a sensed parameter, may obtain information of a number of image forming jobs performed by the image forming apparatus 300, may receive an instruction input by the user interface 320, may receive an instruction input by the communication interface 330, or may obtain information, an instruction, data, etc. from the memory 340. Using any of the received or obtained information, data, or instructions, the processor 310 may control the magnet controller 360 to supply a magnetic material.

The processor 310 may determine a result of controlling the magnet controller 360, may store the result in the memory 340, provide the result to a user through the user interface 320, or provide the result to an external device through the communication interface 330. As an example, the processor 310 may determine a result of controlling the magnet controller 360 using the sensor 380.

In various examples of the disclosure, a magnetic material supply apparatus may allow a user to selectively control supply of a magnetic material to an image forming apparatus. The use of the magnetic material supply apparatus may increase the convenience of the user by, for example, reducing the need to cease an operation of the image forming apparatus or by increasing the selective ability to supply a magnetic material for an image forming job.

While the present disclosure has been shown and described with reference to various examples thereof, it will be understood by those skilled in the art that various changes in form and details may be made therein without departing from the spirit and scope of the present disclosure as defined by the appended claims and their equivalents. Therefore, the scope of the present disclosure should be defined not by the described examples alone, but by the appended claims and the equivalents thereof.

What is claimed is:

1. A magnetic material supply apparatus comprising:
a reservoir to contain a magnetic material;
a connecting member having a first end coupled to the reservoir to receive the magnetic material; and
a magnet,
wherein, a magnetic field produced by the magnet controls supply of the magnetic material through the connecting member.

2. The magnetic material supply apparatus of claim 1,
wherein the magnet comprises a permanent magnet and is movable relative to the connecting member, and
wherein, in a first position of the magnet relative to the connecting member, the magnetic field produced by the magnet prevents the magnetic material from moving through the connecting member.

3. The magnetic material supply apparatus of claim 2, further comprising a magnet controller, coupled to the magnet, to control the movement of the magnet in relation to the connecting member.

4. The magnetic material supply apparatus of claim 3, wherein the magnet controller comprises a solenoid, an actuator, an articulating arm, or a worm gear.

5. The magnetic material supply apparatus of claim 2, wherein, in a second position relative to the connecting member, the magnetic field produced by the magnet allows the magnetic material to move through the connecting member.

6. The magnetic material supply apparatus of claim 1, further comprising one of one or more second magnets or a high magnetic permeability material to control the supply of the magnetic material through the connecting member with the magnet.

7. The magnetic material supply apparatus of claim 1, further comprising a magnet controller,
wherein the magnet comprises an electromagnet, and
wherein the magnet controller controls the magnetic field produced by the magnet to control the supply of the magnetic material through the connecting member.

8. An apparatus for providing a developer, the apparatus comprising:
a first container to contain a volume of a magnetic carrier;
a second container to contain a volume of a developer;
a connecting member having a first end coupled to the reservoir and a second end opposite to the first end, the connecting member to transfer the magnetic carrier from the first container to the second container; and
a magnet movable in relation to the connecting member,
wherein, a magnetic field produced by the magnet controls the transfer of the magnetic carrier through the connecting member.

9. The apparatus of claim 8, wherein, in a first position of the magnet relative to the connecting member, the magnetic field produced by the magnet prevents the magnetic carrier from transferring through the connecting member.

10. The apparatus of claim 8, further comprising a magnet controller, coupled to the magnet, to control the movement of the magnet in relation to the connecting member.

11. The apparatus of claim 10, wherein the magnet controller comprises a solenoid, an actuator, an articulating arm, or a worm gear.

12. The apparatus of claim 8, wherein the first container is provided within the second container.

13. An image forming apparatus comprising:
a reservoir to contain a magnetic carrier;
a developer cartridge to contain a developer;
a connecting member having a first end coupled to the reservoir to receive the magnetic carrier and a second end, opposite to the first end, coupled to developer cartridge, the connecting member to transfer the magnetic carrier from the reservoir to the developer cartridge;
a magnet movable in relation to the connecting member; and
a magnet controller, coupled to the magnet, to control the movement of the magnet in relation to the connecting member,
wherein, a magnetic field produced by the magnet controls movement of the magnetic carrier through the connecting member.

14. The image forming apparatus of claim 12, further comprising:
a processor;
a communication interface;
a user interface; and
a sensor to detect a status of the magnetic carrier in the developer cartridge,
wherein the magnet controller is to control the position of the magnet according to the detected status of the magnetic carrier in the developer cartridge, an external signal received by the communication interface, a user selection received by the user interface, or based on a number of images formed by the image forming apparatus.

15. The image forming apparatus of claim 12,
wherein, in a first position of the magnet relative to the connecting member, the magnetic field produced by the magnet prevents the magnetic carrier from transferring through the connecting member, and
wherein, in a second position of the magnet relative to the connecting member, the magnetic field produced by the magnet allows magnetic particles to transfer through the connecting member.
